(19) United States
(12) Patent Application Publication
(10) Pub. No.: US 2004/0202251 A1
(43) Pub. Date: Oct. 14, 2004

(54) Faster block processing structure for MPEG decoders

(76) Inventor: Savekar Santosh, Karnataka (IN)

Correspondence Address: MCANDREWS HELD & MALLOY, LTD, 500 WEST MADISON STREET, SUITE 3400, CHICAGO, IL, 60661

(21) Appl. No.: 10/409,741

(22) Filed: Apr. 9, 2003

(51) Int. Cl. H04N 7/12

(52) U.S. Cl. 375/240.23; 375/240.01; 375/240.18; 375/240.03; 375/240.2; 375/240.25

(57) ABSTRACT

A system, method, and apparatus for improved and faster block processing structure for MPEG decoders is presented herein. The decoder receives compressed images at a Huffman decoder. The Huffman decoder decodes the variable length code, resulting in quantized DCT coefficients. The Huffman decoder also records the matrix position of non-zero coefficients. The Huffman decoder provides the quantized DCT coefficients and the matrix positions of the non-zero coefficients to an inverse quantizer. The inverse quantizer uses the non-zero coefficients to access and inverse quantize only the non-zero quantized coefficients. The quantizer provides the coefficients and positions of the non-zero coefficients to an inverse zig-zag scanner. The inverse zig-zag scanner creates an all zero DCT matrix and calculates the positions of the non-zero coefficients in the DCT matrix. The non-zero coefficients are added to the DCT matrix at the calculated positions. The decoder then applies inverse DCT (IDCT) to the DCT coefficients, thereby reconstructing the image.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The JPEG (Joint Pictures Experts Group) and MPEG (Motion Picture Experts Group) standards were developed in response to the need for storage and distribution of images and video in digital form. JPEG is one of the primary image-coding formats for still images, while MPEG is one of the primary image-coding formats for motion pictures or video. The MPEG standard includes many variants, such as MPEG-1, MPEG-2, and Advanced Video Coding (AVC). Video Compact Discs (VCD) store video and audio content coded and formatted in accordance with MPEG-1 because the maximum bit rate for VCDs is 1.5 Mbps. The MPEG-1 video stream content on VCDs usually has bit-rate of 1.15 Mbps. MPEG-2 is the choice for distributing high quality video and audio over cable/satellite that can be decoded by digital set-top boxes. Digital versatile discs also use MPEG-2.

Both JPEG and MPEG use discrete cosine transformation (DCT) for image compression. The encoder divides images into 8×8 square blocks of pixels. The 8×8 square blocks of pixels are the basic blocks on which DCT is applied. DCT separates out the high frequency and low frequency parts of the signal and transforms the input spatial domain signal into the frequency domain.

Low frequency components contain information to reconstruct the block to a certain level of accuracy whereas the high frequency components increase this accuracy. The size of the original 8×8 block is small enough to ensure that most of the pixels will have relatively similar values and therefore, on an average, the high frequency components have either zero or very small values.

The human visual system is much more sensitive to low frequency components than to high frequency components. Therefore, the high frequency components can be represented with less accuracy and fewer bits, without much noticeable quality degradation. Accordingly, a quantizer quantizes the 8×8 matrix of frequency coefficients where the high frequency components are quantized using much bigger and hence much coarser quantization steps. The quantized matrix generally contains non-zero values in mostly lower frequency coefficients. Thus the encoding process for the basic 8×8 block works to make most of the coefficients in the matrix prior to run-level coding zero so that maximum compression is achieved. Zig-zag scanning is used so that the low frequency components are grouped together.

After the scan, the matrix is represented efficiently using run-length coding with Huffman Variable Length Codes (VLC). Each run-level VLC specifies the number of zeroes preceding a non-zero frequency coefficient. The “run” value indicates the number of zeroes and the “level” value is the magnitude of the non-zero frequency coefficient following the zeroes. After all non-zero coefficients are exhausted, an end-of-block (EOB) is transmitted in the bit-stream.

Operations at the decoder end happen in exactly the opposite order. The decoder decodes the run-level Huffman symbols first, followed by inverse zig-zag scanning, inverse quantization and IDCT.

The foregoing requires considerable computations and processing at both the encoder and decoder. As the computation and processing requirements of the encoder and decoder increase, the costs of the encoder and decoder also rise. This is especially undesirable at the decoder because the decoder is a consumer product.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention are directed to a decoder for decoding images with less computation and processing power. The decoder receives compressed images at a Huffman decoder. The Huffman decoder decodes the variable length code, resulting in quantized DCT coefficients. The Huffman decoder also records the matrix position of non-zero coefficients. The Huffman decoder provides the quantized DCT coefficients and the matrix positions of the non-zero coefficients to an inverse quantizer. The inverse quantizer uses the non-zero coefficients to access and inverse quantize only the non-zero quantized coefficients. The quantizer provides the coefficients and positions of the non-zero coefficients to an inverse zig-zag scanner. The inverse zig-zag scanner creates an all zero DCT matrix and calculates the positions of the non-zero coefficients in the DCT matrix. The non-zero coefficients are added to the DCT matrix at the calculated positions. The decoder then applies inverse DCT (IDCT) to the DCT coefficients, thereby reconstructing the image.

The foregoing significantly reduces the number of processing operations. The number of Huffman decoding, inverse quantization, and inverse zig-zag operations are reduced from the number of coefficients in the DCT matrix to the number of non-zero coefficients in the DCT matrix. In a typical MPEG-2 case, where the DCT matrix contains 16 non-zero coefficients in a 64 position matrix, the number of operations are reduced by 75%.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for an exemplary system for encoding digital images;

FIG. 2 is a block diagram of an exemplary system for decoding digital images in accordance with an embodiment of the present invention;

FIGS. 3A and 3B are block diagrams describing MPEG Formatting of a video;

FIG. 4 is a block diagram of a decoder configured in accordance with an embodiment of the present invention;

FIG. 5 is a block diagram of an exemplary MPEG video decoder in accordance with an embodiment of the present invention; and

FIG. 6 is a flow diagram for decoding a compressed block in accordance with an embodiment of the present invention.

### DETAILED DESCRIPTION OF THE INVENTION

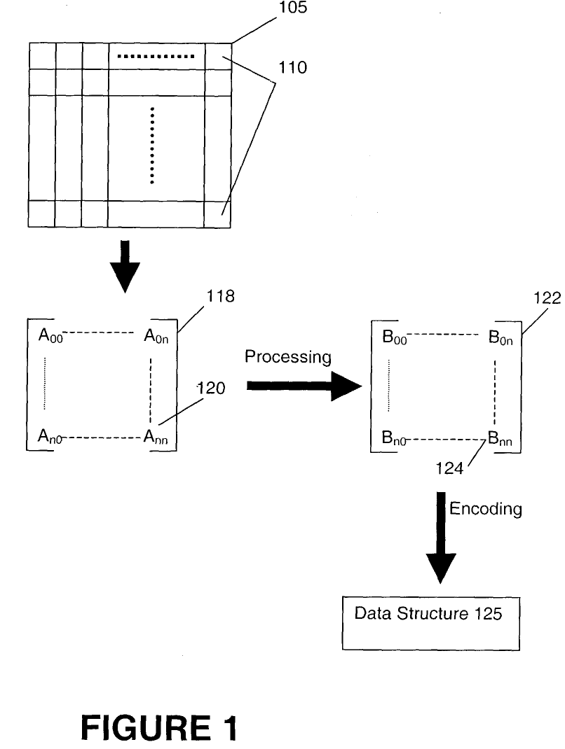

Referring now to FIG. 1, there is illustrated a block diagram describing an exemplary process for compressing digital image data 105. The digital image data 105 can comprise either a portion of a digital image or an entire image. Additionally, the digital image data can comprise a prediction error or offset with respect to other digital image data. The digital image data 105 comprises a two dimensional grid of pixels 110. The digital image data 105 is transformed to the frequency domain by application of a frequency transformation. For example, the frequency transformation can comprise discrete cosine transformation (DCT) or Fast Fourier Transformation (FFT).

A matrix 118 of coefficients 120 corresponding to frequencies (frequency coefficients) represents the digital image pixel data 110 in the frequency domain. Generally, pixel data 110 in close proximity is similar. Accordingly, the higher frequency components are likely to be small or zero. Additionally, the human visual system is much more sensitive to low frequency components than to high frequency components. Therefore, high frequency components can be represented with less accuracy without noticeable quality degradation.

The matrix 118 of frequency coefficient 120 is processed by application of various operations. The operations can include operations that convert the matrix 118 of frequency coefficient 120 into a matrix 122 of processed frequency components 124 that preferably can be encoded with a small amount of data. For example, the frequency coefficients can be quantized, wherein the lower frequency coefficients are quantized using more bits and wherein the higher frequency coefficients are quantized using fewer bits. Additionally, the ordering of the frequency coefficient can be rearranged to concentrate the non-zero-coefficients in one part of the data structure and the zero coefficients in another part.

The matrix 122 of processed frequency coefficients 124 is then encoded into a data structure 125. The encoding encodes the processed frequency components 120 into a data structure 125 that uses a smaller amount of bytes. For example, the data structure 125 can be encoded using a coding scheme that takes advantage of the fact that many of the processed frequency components 120 are zero.

The data structure 125 represents the compressed digital image data and can then be stored in a memory or transmitted over a communication medium. The data structure 125 can also be further processed. For example, if the digital image data is a portion of a larger image, the data structures 125 can be associated with other data structure 125 representing other portions of the digital image in another data structure. Additionally, the data structures 125 can be packetized in a layered hierarchy with various headers. For example, in video compression, a layered hierarchy can be used to associate data structures 125 representing portions of an image, and images associated with a group.

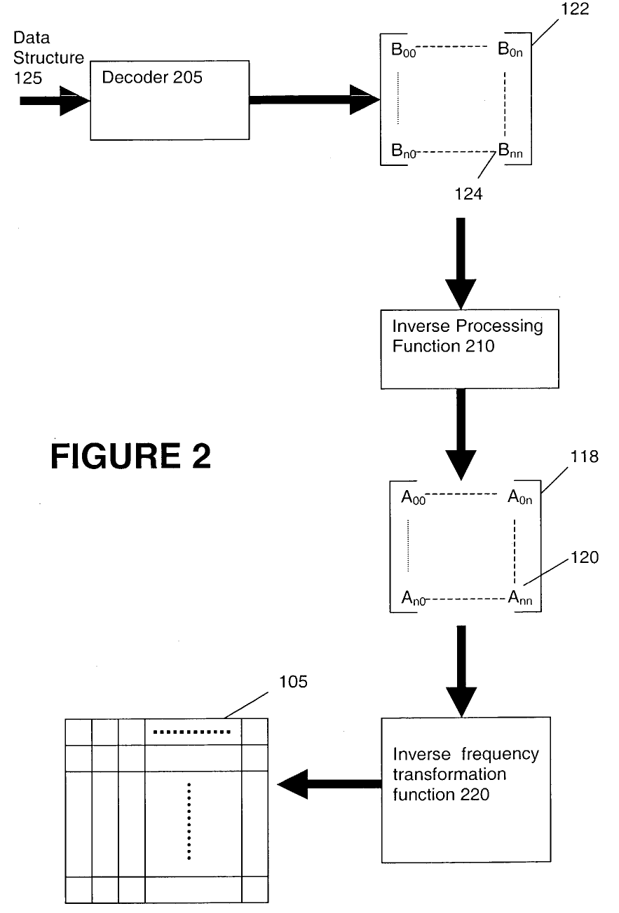

Referring now to FIG. 2, there is illustrated a block diagram describing decoding of compressed digital image data in accordance with an embodiment of the present invention. A decoder 205 receives the data structures 125 and decodes the processed frequency coefficients 124. Additionally, the decoder 205 also records the position of the processed frequency coefficients 124 in the matrix 122.

The matrix 122 of frequency coefficients 120 can be regenerated by inverting the processing operations performed during the compression process. However, many of the processed frequency coefficients 120 are likely to be zero. Additionally, many processing operations on a zero coefficient generate a zero result. Therefore, it is possible to reconstruct the matrix of frequency coefficients 120 by inverting the processing operations for each of the non-zero processed frequency coefficients 124 and adding the results to an all zero matrix. In order to invert the processing operation on each of the non-zero processed frequency coefficients 124, the decoder 205 provides the inverse processing function 210 with each non-zero coefficient 124 and its relative position in the matrix 122. The foregoing reduces the number of inverse quantization, and inverse zig-zag scanning operations needed from the number of matrix coefficients to the to number of non-zero coefficients. As an example, the matrix could have 64 coefficients while only 5 of its coefficients may be non-zero.

The inverse processing function 210 receives the non-zero coefficients 124 and the relative positions of the non-zero coefficients in matrix 122, inverts the processing functions, and cumulatively adds the result to, initially, an all zero matrix 215. When the inverse processing function 210 has inverted the processing functions for each of the non-zero coefficients, the initial matrix 215 reconstructs the matrix 118 of frequency coefficients 120. The matrix 118 of frequency coefficients 120 can then be transformed to the spatial domain by an inverse frequency transformation function 220. The output of the inverse frequency transformation function 220 is the reconstructed digital image data 105.

The MPEG-2 standard and the AVC standard use a variety of techniques to compress video. The compression techniques take advantage of spatial redundancy within an image, as well as temporal redundancy between successive images. The compression techniques include discrete cosine transformation to take advantage of spatial redundancy. Additionally, the MPEG-2 and AVC standards define a hierarchical structure that represents a video. The hierarchical structure includes blocks representing portions of individual images. The blocks are organized in a layered and packetized format to represent the video.

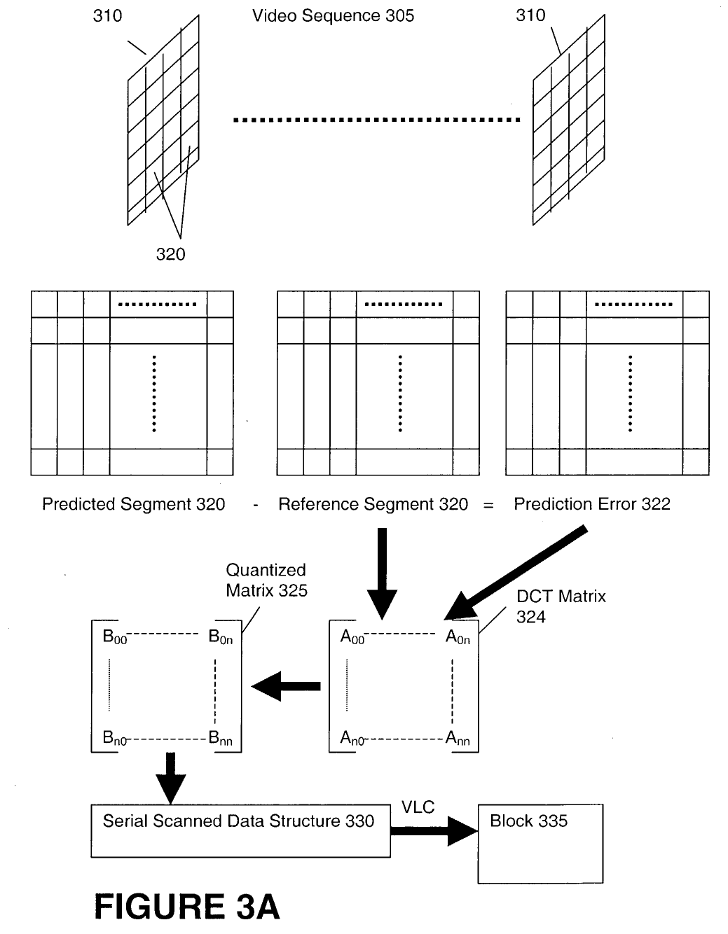

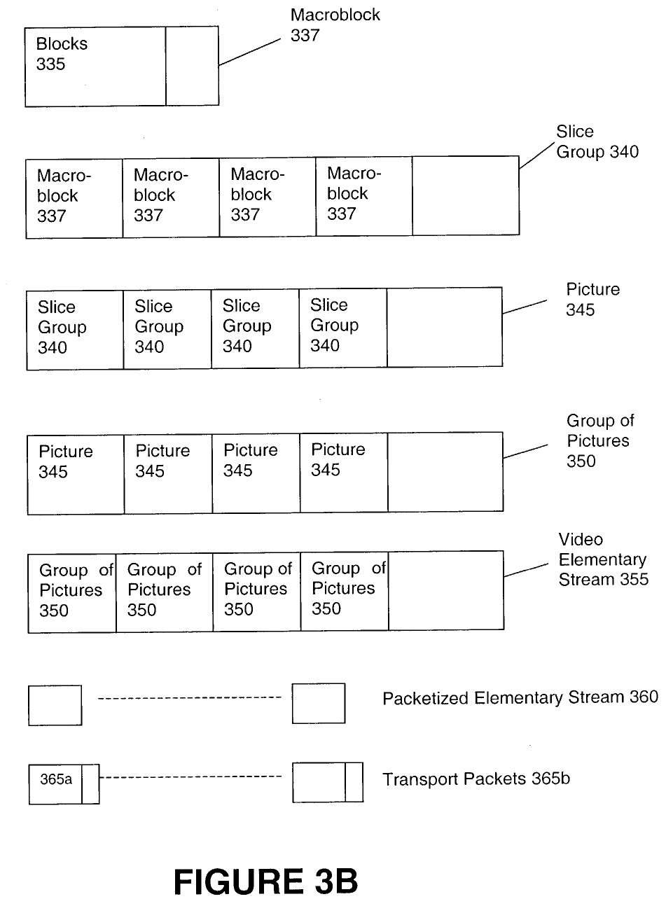

Referring now to FIG. 3A, there is illustrated a block diagram describing MPEG formatting of a video sequence 305. A video sequence 305 comprises a series of frames 310. In a progressive scan, the frames 310 represent instantaneous images, while in an interlaced scan, the frames 310 comprises two fields each of which represent a portion of an image at adjacent times. Each frame comprises a two dimensional grid of pixels 315. The two-dimensional grid of pixels 315 is divided into 8×8 segments 320.

The MPEG standard takes advantage of temporal redundancies between the frames with algorithms that use motion compensation based prediction. The frames 310 can be considered as snapshots in time of moving objects. With frames 310 occurring closely in time, it is possible to represent the content of one frame 310 based on the content of another frame 310, and information regarding the motion of the objects between the frames 310.

Accordingly, segments 320 of one frame 310 (a predicted frame) are predicted by searching segment 320 of a reference frame 310 and selecting the segment 320 in the reference frame most similar to the segment 320 in the predicted frame. A motion vector indicates the spatial displacement between the segment 320 in the predicted frame (predicted segment) and the segment 320 in the reference frame (reference segment). The difference between the pixels in the predicted segment 320 and the pixels in the reference segment 320 is represented by an 8×8 matrix known as the prediction error 322. The predicted segment 320 can be represented by the prediction error 322, and the motion vector.

In MPEG-2, the frames 310 can be represented based on the content of a previous frame 310, based on the content of a previous frame and a future frame, or not based on the content of another frame. In the case of segments 320 in frames not predicted from other frames, the pixels from the segment 320 are transformed to the frequency domain using DCT, thereby resulting in a DCT matrix 324. For predicted segments 320, the prediction error matrix is converted to the frequency domain using DCT, thereby resulting in a DCT matrix 324.

The segment 320 is small enough so that most of the pixels are similar, thereby resulting in high frequency coefficients of smaller magnitude than low frequency components. In a predicted segment 320, the prediction error matrix is likely to have low and fairly consistent magnitudes. Accordingly, the higher frequency coefficients are also likely to be small or zero. Therefore, high frequency components can be represented with less accuracy and fewer bits without noticeable quality degradation.

The coefficients of the DCT matrix 324 are quantized, using a higher number of bits to encode the lower frequency coefficients 324 and fewer bits to encode the higher frequency coefficients 324. The fewer bits for encoding the higher frequency coefficients 324 cause many of the higher frequency coefficients 324 to be encoded as zero. The foregoing results in a quantized matrix 325.

As noted above, the higher frequency coefficients in the quantized matrix 325 are more likely to contain zero value. In the quantized frequency components 325, the lower frequency coefficients are concentrated towards the upper left of the quantized matrix 325, while the higher frequency coefficients 325 are concentrated towards the lower right of the quantized matrix 325. In order to concentrate the non-zero frequency coefficients, the quantized frequency coefficients 325 are diagonally scanned starting from the top left corner and ending at the bottom right corner, thereby forming a serial scanned data structure 330.

The serial scanned data structure 330 is encoded using variable length coding, thereby resulting in blocks 335. The VLC specifies the number of zeroes preceding a non-zero frequency coefficient. A “run” value indicates the number of zeroes and a “level” value is the magnitude of the nonzero frequency component following the zeroes. After all non-zero coefficients are exhausted, an end-of-block signal (EOB) indicates the end of the block 335.

Continuing to FIG. 3B, a block 335 forms the data portion of a macroblock structure 337. The macroblock structure 337 also includes additional parameters, including motion vectors.

Blocks 335 representing a frame are grouped into different slice groups 340. In MPEG-2, each slice group 340 contains contiguous blocks 335. The slice group 340 includes the macroblocks representing each block 335 in the slice group 340, as well as additional parameters describing the slice group. Each of the slice groups 340 forming the frame form the data portion of a picture structure 345. The picture 345 includes the slice groups 340 as well as additional parameters. The pictures are then grouped together as a group of pictures 350. Generally, a group of pictures includes pictures representing reference frames (reference pictures), and predicted frames (predicted pictures) wherein all of the predicted pictures can be predicted from the reference pictures and other predicted pictures in the group of pictures 350. The group of pictures 350 also includes additional parameters. Groups of pictures are then stored, forming what is known as a video elementary stream 355.

The video elementary stream 355 is then packetized to form a packetized elementary sequence 360. Each packet is then associated with a transport header 365a, forming what are known as transport packets 365b.

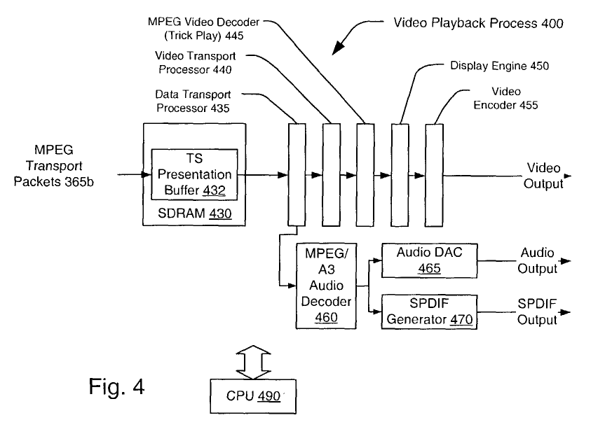

Referring now to FIG. 4, there is illustrated a block diagram of an exemplary decoder for decoding compressed video data, configured in accordance with an embodiment of the present invention. A processor, that may include a CPU 490, reads a stream of transport packets 365b (a transport stream) into a transport stream buffer 432 within an SDRAM 430. The data is output from the transport stream presentation buffer 432 and is then passed to a data transport processor 435. The data transport processor then demultiplexes the MPEG transport stream into its PES constituents and passes the audio transport stream to an audio decoder 460 and the video transport stream to a video transport processor 440. The video transport processor 440 converts the video transport stream into a video elementary stream and provides the video elementary stream to an MPEG video decoder 445 that decodes the video. The audio data is sent to the output blocks and the video is sent to a display engine 450. The display engine 450 is responsible for and operable to scale the video picture, render the graphics, and construct the complete display among other functions. Once the display is ready to be presented, it is passed to a video encoder 455 where it is converted to analog video using an internal digital to analog converter (DAC). The digital audio is converted to analog in the audio digital to analog converter (DAC) 465.

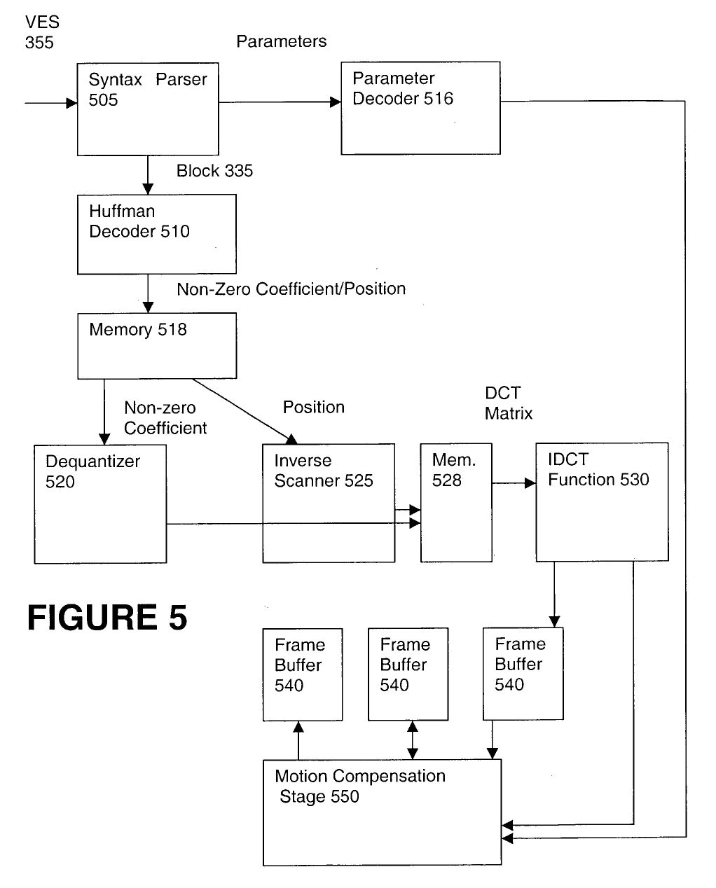

Referring now to FIG. 5, there is illustrated a block diagram of an MPEG video decoder 445 in accordance with an embodiment of the present invention. The MPEG video decoder 445 comprises three functional stages—a parsing stage, an inverse transformation stage, and a motion compensation stage. The parsing stage receives the video elementary stream, decodes the parameters, and decodes the variable, length code. The parsing stage includes a syntax parser 505, a run level Huffman decoder 510, and a parameter decoder 516.

The syntax parser 505 receives the video elementary stream 355 and separates the parameters from the blocks 335. The syntax parser 505 provides the parameters to the parameter decoder 516, and the blocks 335 to the Huffman decoder 510. The Huffman decoder 510 processes the blocks 335, recovers each non-zero value, and determines a position of the non-zero value in the scanned structure 330. The Huffman decoder 510 pairs each non-zero coefficient with its position and stores the non-zero coefficient position pair in memory 518.

The inverse transformation stage transforms the coefficients from the frequency domain to the spatial domain. The inverse transformation stage includes an inverse quantizer 520, an inverse scanner 525, and an IDCT function 530. For each non-zero coefficient position pair in the memory 518, the inverse quantizer 520 reads the non-zero coefficient, while the inverse scanner 525 reads the position.

The dequantizer 520 dequantizes the non-zero coefficient, while the inverse scanner 525 determines a matrix position corresponding to the scan position. The determination of the matrix position corresponding to the scan position can be achieved by means of a lookup table. An exemplary lookup table, wherein positions are represented in binary code is presented in TABLE 1.

TABLE 1
Row Number Represents Most Significant Bits
Column Number Represents Least Significant Bits

| | 000 | 001 | 010 | 011 | 100 | 101 | 110 | 111 |
|---|---|---|---|---|---|---|---|---|
| 000 | 0, 0 | 0, 1 | 1, 0 | 2, 0 | 1, 1 | 0, 2 | 0, 3 | 1, 2 |
| 001 | 2, 1 | 3, 0 | 4, 0 | 3, 1 | 2, 2 | 1, 3 | 0, 4 | 0, 5 |
| 010 | 1, 4 | 2, 3 | 3, 2 | 4, 1 | 5, 0 | 6, 0 | 5, 1 | 4, 2 |
| 011 | 3, 3 | 2, 4 | 1, 5 | 0, 6 | 0, 7 | 1, 6 | 2, 5 | 3, 4 |
| 100 | 4, 3 | 5, 2 | 6, 1 | 7, 0 | 7, 1 | 6, 2 | 5, 3 | 4, 4 |
| 101 | 3, 5 | 2, 6 | 1, 7 | 2, 7 | 3, 6 | 4, 5 | 5, 4 | 6, 3 |
| 110 | 7, 2 | 7, 3 | 6, 4 | 5, 5 | 4, 6 | 3, 7 | 4, 7 | 5, 6 |
| 111 | 6, 5 | 7, 4 | 7, 5 | 6, 6 | 5, 7 | 6, 7 | 7, 6 | 7, 7 |

The dequantizer provides the dequantized coefficient to the inverse scanner 525. The inverse scanner 525 places the dequantized coefficient in the matrix position of a matrix.

The inverse scanner 525 creates a DCT matrix by allocating memory 528 for an 8×8 element all 0 matrix structure at the start of the decoding process for each block. As the dequantized coefficients are provided, the inverse scanner 525 determines the position in the matrix and stores the dequantized coefficient, thereat. After each non-zero dequantized coefficient is placed in the matrix structure, the DCT matrix is complete.

The foregoing significantly reduces the number of processing operations. The number of Huffman decoding, inverse quantization, and inverse zig-zag operations are reduced from the number of coefficients in the DCT matrix to the number of non-zero coefficients in the DCT matrix. In a typical MPEG-2 case, where the DCT matrix contains 16 non-zero coefficients in a 64 position matrix, the number of operations are reduced by 75%.

Additionally, the variable length decoding, dequantization, and inverse scanning operations can occur in a pipelined manner. For example, if s0, s1, and s2 are three consecutive non-zero coefficients, the Huffman decoder 510 can decode s2, while the dequantizer inverse quantizes s1, and the inverse zig-zag scanner places the inverse quantized coefficient s0 at an appropriate position in the all-zero matrix. Moreover, inverse zig-zag scanning and dequantizing operations can be combined for faster processing.

The IDCT retrieves the DCT matrix from memory 528 and converts the DCT matrix to the spatial domain. Where the block 535 decoded corresponds to a reference frame, the output of the IDCT is the pixels forming a segment 320 of the frame. The IDCT provides the pixels in a reference frame 310 to a reference frame buffer 540. The reference frame buffer combines the decoded blocks 535 to reconstruct a frame 310. The frames stored in the frame buffer 540 are provided to the display engine.

Where the block 335 decoded corresponds to a predicted frame 310, the output of the IDCT is the prediction error with respect to a segment 320 in a reference frame(s) 310. The IDCT provides the prediction error to the motion compensation stage 550. The motion compensation stage 550 also receives the motion vector(s) from the parameter decoder 516. The motion compensation stage 550 uses the motion vector(s) to select the appropriate segments 320 blocks from the reference frames 310 stored in the reference frame buffer 540. The segments 320 from the reference picture(s), offset by the prediction error, yield the pixel content associated with the predicted segment 320. Accordingly, the motion compensation stage 550 offsets the segments 320 from the reference block(s) with the prediction error, and outputs the pixels associated of the predicted segment 320. The motion compensation 550 stage provides the pixels from the predicted block to another frame buffer 540. Additionally, some predicted frames are reference frames for other predicted frames. In the case where the block is associated with a predicted frame that is a reference frame for other predicted frames, the decoded block is stored in a reference frame buffer 540.

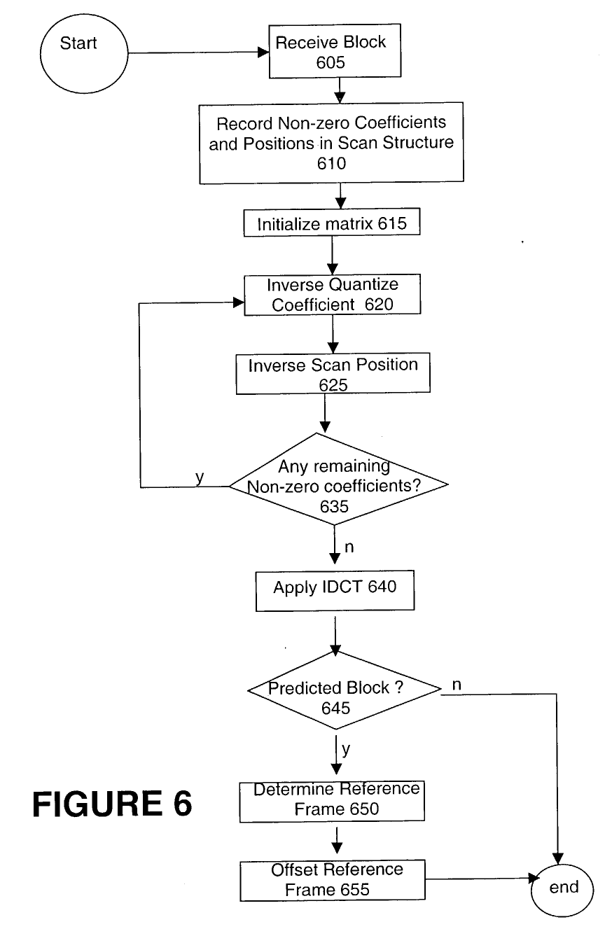

Referring now to FIG. 6, there is illustrated a flow diagram for decoding a compressed block in accordance with an embodiment of the present invention. At 605, the block is received. At 610, the non-zero coefficients and the positions of the non-zero coefficients in scan structure are recorded. At 615, an 8×8 all zero matrix is initialized. At 620, one of the recorded non-zero coefficients is inverse quantized, while the position of the non-zero coefficient is converted (625) to inverse scan position order. At 630, the inverse quantized non-zero coefficient during 620 is stored in the matrix at the inverse scan position from 625. At 635, a determination is made whether there are remaining non-zero coefficients. If there are remaining non-zero coefficients during 635, 620-630 are repeated. When all of the non-zero coefficients are inverse quantized and placed in the matrix, the IDCT transformation (640) is applied to the matrix. At 645, a determination is made whether the block decoded is a predicted block.

If the block decoded is a predicted block, the IDCT transformed matrix is a prediction error from a segment 320 in a reference frame 310. Accordingly, at 650, the segment 320 in the reference frame is determined and offset (655) by the prediction error. The reference segment offset by the prediction error results in the reconstructed pixels of the segment 320 associated with the block and the process is complete. If the block decode is not a predicted block (during 645), the IDCT transformed matrix contains the reconstructed pixels associated with a segment 320 of a frame 310 and the process is complete.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for decoding a data structure, said method comprising:
receiving a first data structure comprising a plurality of frequency coefficients, wherein a portion of the frequency coefficients are non-zero;
recording the frequency coefficients that are non-zero; and
recording positions associated with the recorded frequency coefficients, wherein the positions correspond to locations in a second data structure.

2. The method of claim 1, wherein recording the frequency coefficients further comprises:
decoding the first data structure; and
determining the positions of the frequency coefficients that are non-zero based on the first data structure.

3. The method of claim 1, wherein the first data structure is variable length coded.

4. The method of claim 1, further comprising:
storing the recorded frequency coefficients in the second data structure at the locations corresponding to the positions associated with the recorded frequency coefficients.

5. The method of claim 4, further comprising:
transforming the frequency coefficients into spatial domain components.

6. The method of claim 5, wherein transforming the frequency components into spatial domain components further comprises the inverse discrete cosine transformation.

7. The method of claim 1, further comprising:
inverse quantizing the frequency components of the portion of the frequency components which are non-zero.

8. A decoder for decoding a data structure, said decoder comprising:
a variable length decoder for variable length decoding a first data structure comprising a plurality of frequency coefficients, wherein a portion of the frequency coefficients are non-zero;
a first memory for storing the frequency coefficients that are non-zero; and
a second memory for storing positions associated with the recorded frequency coefficients, wherein the positions correspond to locations in a second data structure.

9. The decoder of claim 8, wherein the variable length decoders determines the positions of the frequency coefficients that are non-zero based on the first data structure.

10. The decoder of claim 8, further comprising:
a third memory for storing the frequency coefficients in the second data structure at the locations corresponding to the positions associated with the recorded frequency coefficients.

11. The decoder of claim 10, further comprising:
a transformation engine for transforming the frequency coefficients to spatial domain.

12. The decoder of claim 11, wherein the transformation engine further comprises an inverse discrete cosine transformation engine.

13. An MPEG video decoder for decoding blocks, said MPEG video decoder comprising:
a variable length decoder that receives the blocks, wherein the blocks comprises a plurality of coefficients, and wherein a portion of the plurality of coefficients are non-zero;
a first memory connected to the variable length decoder, wherein the variable length decoder stores the coefficients that are non-zero; and
a second memory connected to the variable length decoder, wherein the variable length decoder stores positions corresponding to locations in a matrix associated with the non-zero coefficients.

14. The MPEG video decoder of claim 13, further comprising:
an inverse quantizer connected to the first memory, wherein the inverse quantizer inverse quantizes the non-zero coefficients.

15. The MPEG video decoder of claim 14, further comprising:
a third memory storing the matrix;
an inverse zig-zag scanner connected to the second memory and the third memory, wherein the inverse zig-zag scanner stores the inverse quantized non-zero coefficients in locations in the matrix corresponding to the positions associated with the non-zero coefficients.

16. The MPEG video decoder of claim 13, further comprising:
a third memory for storing the non-zero frequency coefficients in the second data structure at the locations corresponding to the positions associated with the non-zero frequency coefficients.

17. The MPEG video decoder of claim 16, further comprising:
a transformation engine connected to the third memory, wherein the transformation engine transforms the non-zero coefficients to spatial domain.

18. The MPEG decoder of claim 17, wherein the transformation engine further comprises an inverse discrete cosine transformation engine.
